(19) United States
(12) Patent Application Publication
(10) Pub. No.: US 2013/0019219 A1
(43) Pub. Date: Jan. 17, 2013

(54) SYSTEM AND METHOD FOR HIERARCHY RECONSTRUCTION FROM FLATTENED GRAPHIC DATABASE SYSTEM LAYOUT

(71) Applicants: Shu-Yu Chen, Hsinchu City (TW); Yi-Tang Lin, Hsinchu City (TW); Cheok-Kei Lei, Andar (MO); Hsiao-Hui Chen, Hsinchu City (TW); Yu-Ning Chang, Hsinchu City (TW); Hsingjen Wann, Carmel, NY (US); Chih-Sheng Chang, Hsinchu (TW); Chien-Wen Chen, Hsinchu City (TW)

(72) Inventors: Shu-Yu Chen, Hsinchu City (TW); Yi-Tang Lin, Hsinchu City (TW); Cheok-Kei Lei, Andar (MO); Hsiao-Hui Chen, Hsinchu City (TW); Yu-Ning Chang, Hsinchu City (TW); Hsingjen Wann, Carmel, NY (US); Chih-Sheng Chang, Hsinchu (TW); Chien-Wen Chen, Hsinchu City (TW)

(73) Assignee: TAIWAN SEMICONDUCTOR MANUFACTURING COMPANY, LTD., Hsin-Chu (TW)

(21) Appl. No.: 13/182,338

(22) Filed: Jul. 13, 2011

(51) Int. Cl. G06F 17/50

(52) U.S. Cl. 716/111

(57) ABSTRACT

System and method for hierarchy reconstruction from a flattened layout are described. In one embodiment, a method for producing a reconstructed layout for an integrated circuit design from an original layout and a revised layout includes, for each pattern of the original layout, determining a pattern of the revised layout that corresponds to the pattern of the original layout; and assigning the corresponding pattern of the revised layout to a temporary instance, the temporary instance corresponding to an instance of the pattern of the original layout and citing to a temporary cell. The method further includes creating a temporary reconstructed layout from the temporary instances; and producing the reconstructed layout from the temporary reconstructed layout, wherein a hierarchy of the reconstructed layout is similar to a hierarchy of the original layout.

### BACKGROUND

Graphic Database System (“GDSII”) and its successor, Open Artwork System Interchange Standard (“OASIS”), are design data layout formats commonly used in the design of integrated circuits (“ICs”). Generally, the data within a GDSII or OASIS file is organized by cell, with, in some instances, lower-level references to other dependent cells, referred to as “subcells”.

To simplify the design process and layout complexity, GDSII and OASIS files are created using a hierarchical structure. For repeated portions, subcells are defined and a parent cell just creates many instances as necessary, which instances are linked to the original subcell using a pointer with a designated orientation. This structure can also reduce the huge file size. For some layout treatments, such as transferring planar layout to FinFET layout or inserting dummy layers in to a sparse layout, the original hierarchical layout is flattened after the treatment. Currently there is no EDA tool utility that supports hierarchy reconstruction after flattening.

The flattened layout suffers from multiple deficiencies. For example, the layout structure of each subcell cannot be individually analyzed after the layout has been flattened. Additionally, simulation cannot be individually run for each subcell after flattening. Finally, the size of the flattened cell is too large, resulting in an excessively long runtime.

Since the flattened layout omits the hierarchical information of instances, only, one top cell without any subcells is represented. After the layout transfer or modification, challenges are presented by the partially or fully flattened layout during process development due to the fact that individual simulation and analysis on the layout structure cannot be performed for the designated segments (i.e., the original subcells).

It will be recognized that any type of layout pattern modification, such as OPC, LOP, dummy insertion, or other transformations, may affect geometric patterns in the layout. In addition to geometry, such transformations may destroy layout hierarchy by partial or complete flattening. In contrast to the original layout, the revised layout is hard to analyze, review, modify and/or perform LVS/LPE/post-simulation at the sub-cell level since the hierarchy is destructively altered by the transformation. On the other hand, such processes are ineffective, inefficient, and time-consuming when performed at the top level. One manner in which the difficulties caused by pattern modification may be alleviated would be to make the hierarchy of revised layout more similar that of the original layout.

In view of the foregoing, what is needed are system and method for reconstructing a hierarchical layout from a partially or fully flattened layout in which the original hierarchy is destroyed by pattern modification.

### BRIEF DESCRIPTION OF THE DRAWINGS

The present disclosure is best understood from the following detailed description when read with the accompanying figures. It is emphasized that, in accordance with the standard practice in the industry, various features are not drawn to scale and are used for illustration purposes only. In fact, the dimensions of the various features may be arbitrarily increased or reduced for clarity of discussion.

FIGS. 1A-7B collectively illustrate the concept of hierarchy and layout structure in a design data layout system such as GDSII or OASIS, for example.

FIGS. 8A-8D collectively illustrate the concept of coordinate translation in accordance with one embodiment.

FIG. 9 illustrates the concept of array instances in accordance with one embodiment.

FIG. 10 illustrates the concept of the property of magnification of a cell as designated in a particular instance in accordance with one embodiment.

FIG. 11 illustrates a hierarchy reconstruction system in accordance with one embodiment for constructing a reconstructed layout having a hierarchy similar to an original layout from the original layout and a revised layout.

FIG. 12 illustrates the effects of pattern modification in accordance with one embodiment.

FIG. 13 illustrates hierarchy reconstruction in accordance with one embodiment.

FIG. 14 illustrates exemplary hierarchy trees for an original layout, a revised layout, and a reconstructed layout used in connection with a hierarchy reconstruction method of one embodiment.

FIG. 15 illustrates a flowchart of the operation of a hierarchy reconstruction system of one embodiment.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over, or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. For example, if the device in the figures is turned over, elements described as being “below” or “beneath” other elements or features would then be oriented “above” the other elements or features. Thus, the exemplary term “below” can encompass both an orientation of above and below. The apparatus may be otherwise oriented (rotated 90 degrees or at other orientations) and the spatially relative descriptors used herein may likewise be interpreted accordingly.

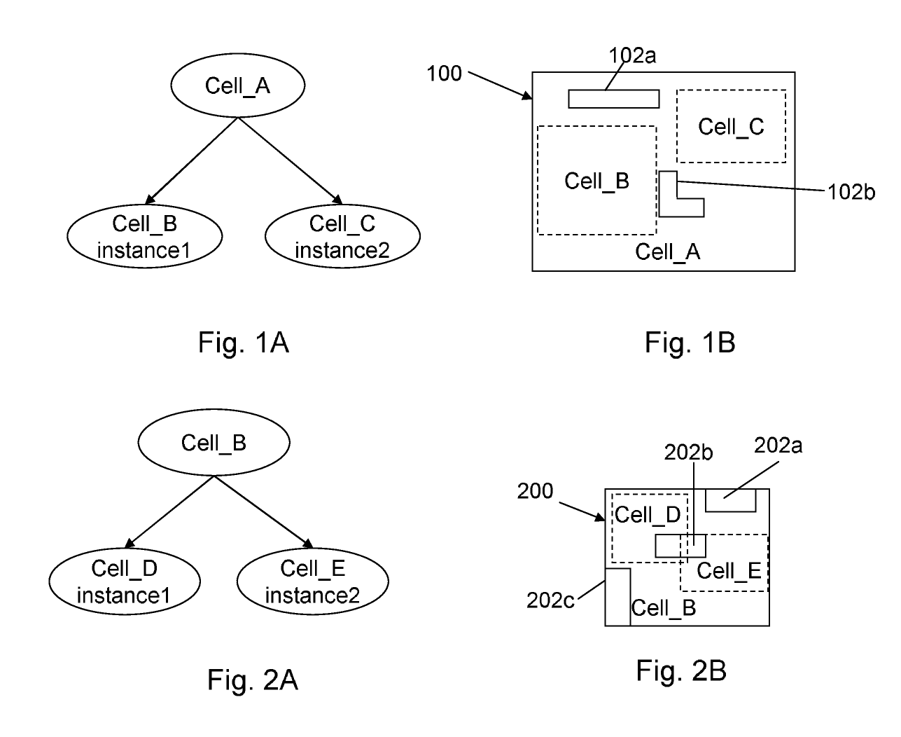

FIGS. 1A-7B collectively illustrate the concept of hierarchy and layout structure in a design data layout system such as GDSII or OASIS, for example. Referring first to FIG. 1, a first cell, designated cell_A, comprises two instances, respectively designated cell_B and cell_C.

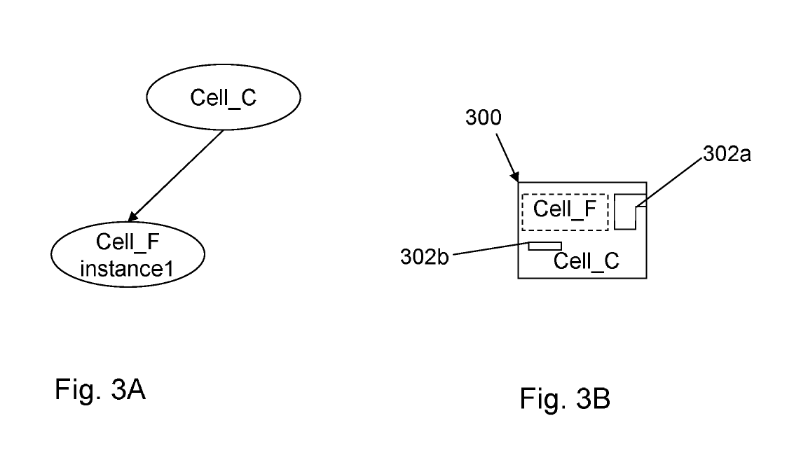

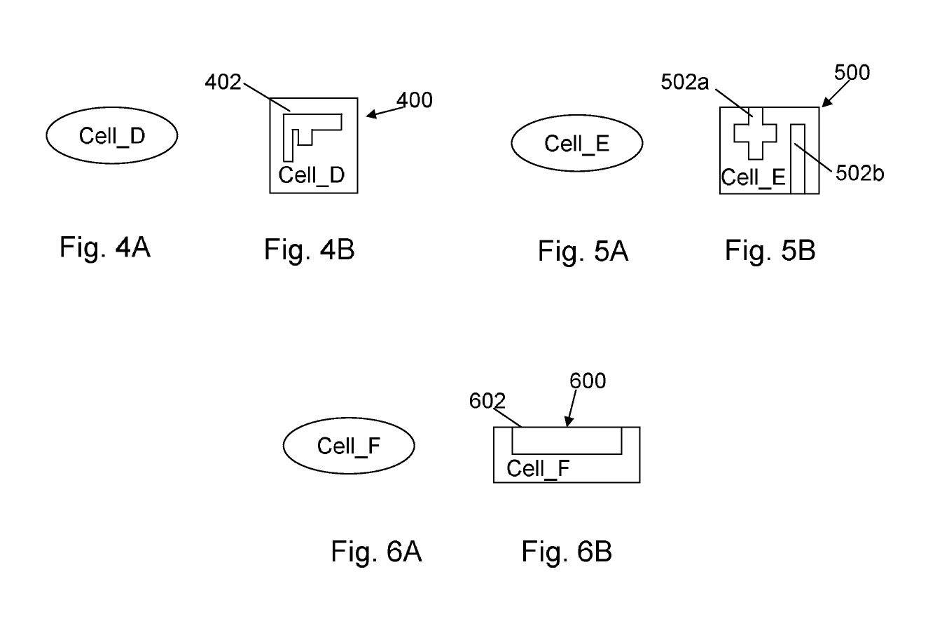

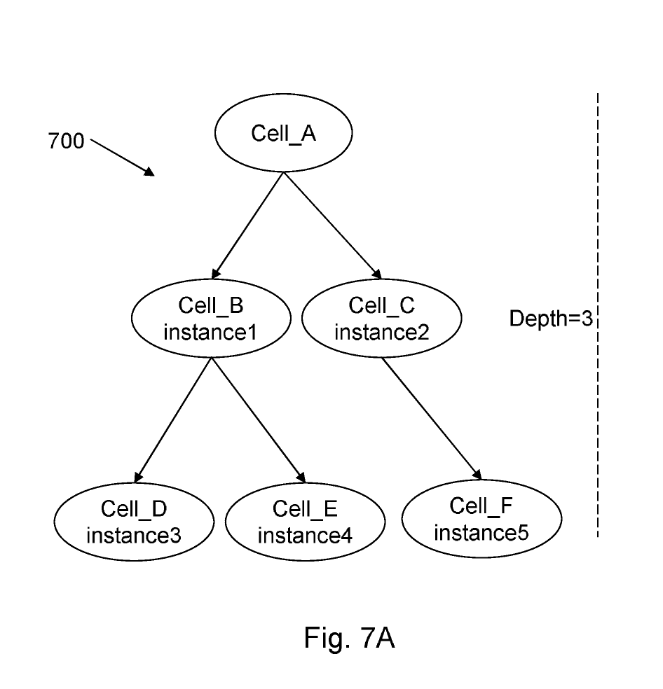

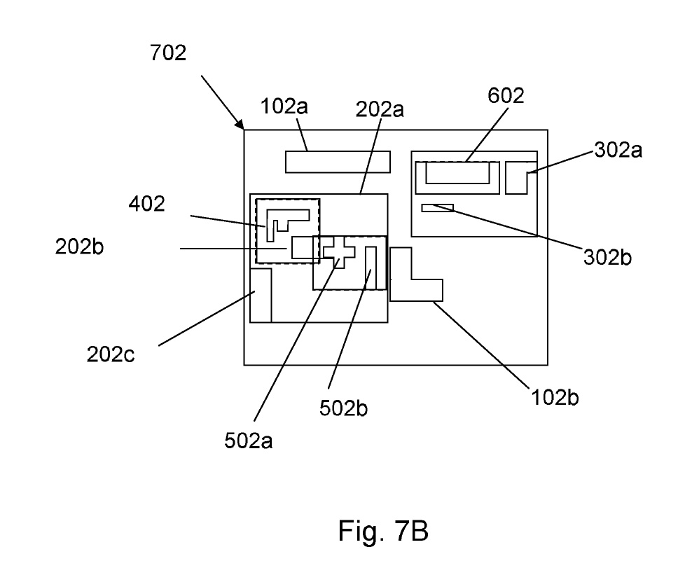

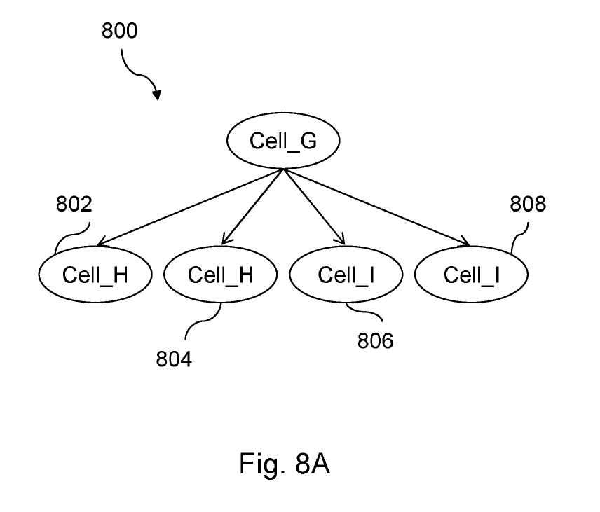

Each of the instances of cell_A are also referred to as “children” of cell_A, which in turn is referred to as the “parent” of cell_B and cell_C. Additionally, since cell_A is the overall parent of the design, i.e., it has no parent itself, cell_A is also referred to as the “top cell.” FIG. 1B illustrates a layout 100 of cell_A, which includes patterns 102a and 102b, as well as cell_B and cell_C. As shown in FIG. 2A, cell_B also has two instances, or children, designated cell_D and cell_E. FIG. 2B illustrates the layout 200 of cell_B, which includes patterns 202a, 202b, and 202c, as well as cell_D and cell_E. As shown in FIG. 3A, cell_C has one instance, designated cell_F. FIG. 3B illustrates the layout 300 of cell_C. which includes patterns 302a and 302b, as well as cell_F. As shown in FIG. 4A, cell_D has no instances. A cell with no instances is referred to herein as a “leaf cell.” FIG. 4B illustrates the layout 400 of cell_D, which includes one pattern 400. Similarly, as shown in FIG. 5A, cell_E has no instances and is therefore also a leaf cell. FIG. 5B illustrates the layout 500 of cell_E, which includes patterns 502a and 502b. Finally, as shown in FIG. 6A, cell_F is also a leaf cell. FIG. 6B illustrates the layout 600 of cell_F, which includes one pattern 602.

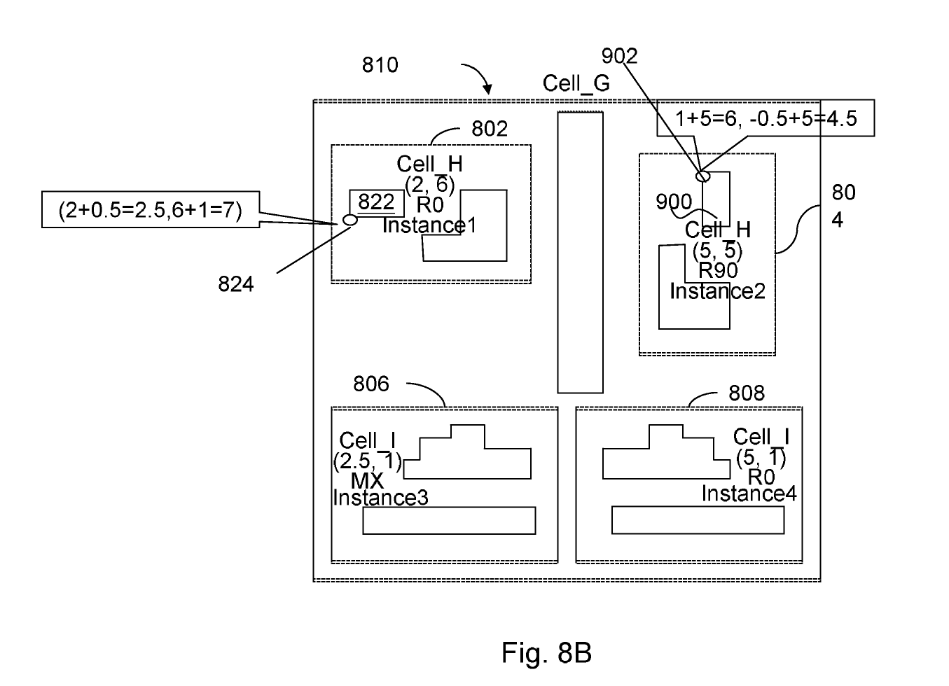

FIG. 7A illustrates a hierarchy tree 700 of cell_A. As shown in FIG. 7A, cell_A includes two instances and a total of five subcells, including cell_B, cell_C, cell_D, cell_E, and cell_F. In particular, cell_A is the parent of cell_B and cell_C; cell_B is the parent of cell_D and cell_E; and cell_C is the parent of cell_F. FIG. 7B illustrates the complete layout 702 of cell_A showing the relative locations of all of the patterns 102a-602 of all of cell_B-cell_F.

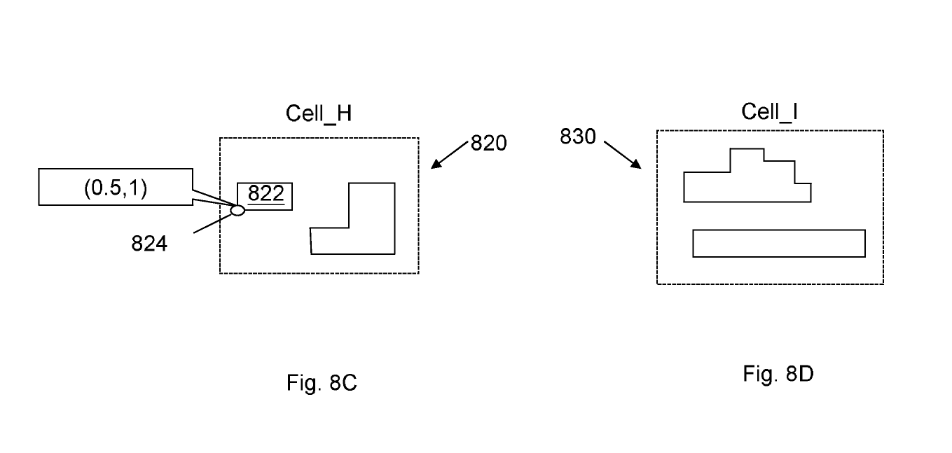

FIGS. 8A-8D collectively illustrate the concept of coordinate translation in accordance with one embodiment. As will be illustrated below, there are two types of orientation that an instance of a child cell may have within its parent cell. One type is rotation; “R0” indicates no rotation of the instance of the cell relative to the original pattern, “R90” indicates a 90 degree rotation of the cell instance relative to the original pattern, “R180” indicates a 180 degree rotation of the cell instance relative to the original pattern, and “R270” indicates a 270 degree rotation of the cell instance relative to the original pattern. The other type of orientation is mirror image; “MX” indicates the instance is a mirror image of the cell along the X axis and “MY” indicates the instance is a mirror image of the cell along the Y axis. Each instance indicates the cited cell and the orientation of the current cell instance relative to the cited cell. With children and orientation information for each cell, we can obtain overall chip by performing a top-down trace starting from the top cell.

Referring to FIG. 8A, a hierarchy tree 800 illustrated therein comprises three cells (cell_G, cell_H, and cell_I). Cell_G is the top cell 801 of the tree 800 and the parent cell of cell_H and cell_I. Cell_G comprises four instances 802-808 of cell_H and cell_I. The layout of cell_G is illustrated in FIG. 8B and designated by a reference numeral 810. The layouts of cell_H and are respectively illustrated in FIGS. 8C and 8D and designated by reference numerals 820 and 830. Referring again to FIG. 8A, the first instance 802 cites to cell_H, has an orientation of R0, and is located at coordinates (2, 6) within the top cell, cell_G, which is also its parent cell. The second instance 804 also cites to cell_H, has an orientation of R90, and is located at coordinates (5, 5) within cell_G. The third instance 806 cites to cell_I, has an orientation MX, and is located at coordinates (2.5, 1) within cell_G. The fourth instance 808 cites to cell_I, has an orientation R0, and is located at coordinates (5, 1) within cell_G.

The coordinates of an instance after it is translated to the parent cell may be determined using one or more known methods. For example, assuming the left bottom corner of an pattern 822 in cell_H (FIG. 8C), designated by a point 824, is located at coordinates (0.5, 1) in the layout 820 of cell_H, its coordinate location in the instance 800 within the layout 810 of cell_G will be (2+0.5=2.5, 6+1=7). Similarly, the coordinate location of the same point 824 in the instance 802 within the layout 810 of cell_G, accounting for the 90 degree rotation of the instance 902, will be (1+5=6, −0.5+5=4.5). The relative locations of each of the remaining patterns of the instances 802-808 within the layout 810 of cell_G may be similarly determined.

To rotate a set of coordinates, one may simply apply a the following rotation matrix, in which θ is the angle of rotation:

$$R = [ \begin{matrix}cos θ & - sin θ \\ sin θ & cos θ\end{matrix} ]$$

Accordingly, if the angle of rotation is 90 degrees, the rotation matrix will be:

$$R ( 90 ° ) = [ \begin{matrix}0 & - 1 \\ 1 & 0\end{matrix} ]$$

For a 180 degree rotation, the rotation matrix will be:

$$R ( 180 ° ) = [ \begin{matrix}- 1 & 0 \\ 0 & - 1\end{matrix} ]$$

For a 270 degree rotation, the rotation matrix will be:

$$R ( 270 ° ) = [ \begin{matrix}0 & 1 \\ - 1 & 0\end{matrix} ]$$

With regard to mirror translation, for MX translation, the y coordinate of a coordinate set is converted to its negative value. For example, the MX translation of original coordinate set (5, −4) is (5, 4). Similarly, for MY translation, the x coordinate of the coordinate set is converted to its negative value; therefore, the MY translation of the coordinate set (5, −4) is (−5, −4).

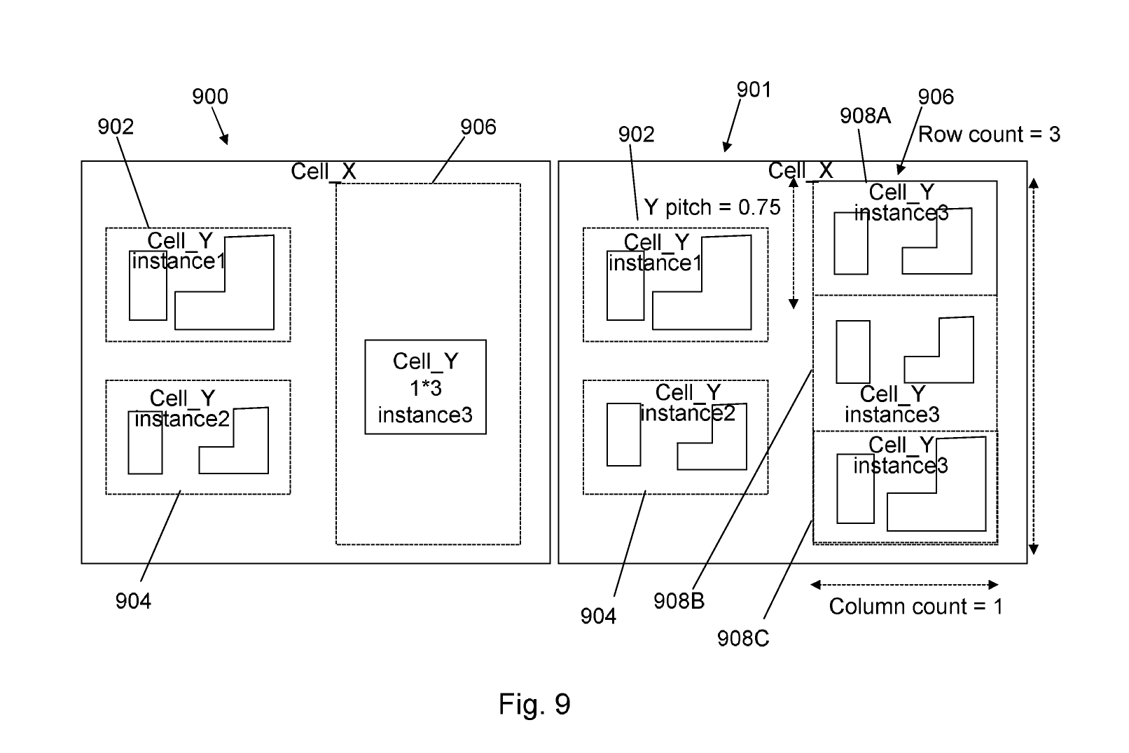

FIG. 9 illustrates the concept of array instances. Most of the time, each instance cites to a single cell one time and is placed at a designated location in its parent, as illustrated in FIG. 8B, for example. However, when several instances that cite to the same cell exist within a parent cell with a spatial regularity, an array instance may be created to simplify the layout design. Referring to FIG. 9, a first representation 900 and a second representation 901 of the layout of a cell designated cell_X are shown. The first layout 900 includes two instances 902, 904, both of which cite to cell_Y, and an array instance 906 that also cites to cell_Y in a 1*3 matrix. This means that cell_Y is cited for the array instance 906 three times (as indicated by the size of the matrix) and is arranged in the left-to-right, bottom-to-top manner according to the specified column and row count (1 and 3, respectively) and with the specified pitch (e.g., Y pitch=0.75) for instances 908A, 908B, 908C, comprising the array instance 906 as shown in the second layout 901. Such array instance properties will affect the relative coordinates for the patterns in the instances comprising the array instance 906 (as illustrated in FIGS. 1A-7B) and must therefore be accounted for when the hierarchy is flattened.

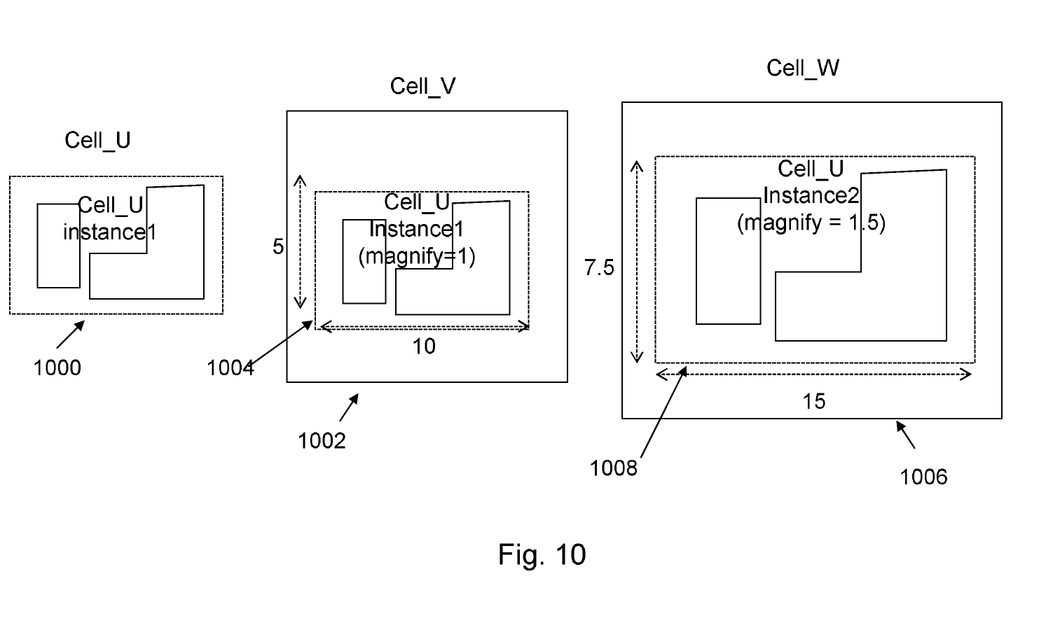

FIG. 10 illustrates the concept of the property of magnification of a cell as designated in a particular instance. In the illustrated example, it will be assumed that the width of an instance 1000 citing to a cell designated cell_U is 10 units and the height thereof is 5 units. Reference numeral 1002 designates an instance of a parent cell designated cell_V that contains an instance 1004 citing cell_U with magnify set to “1.” As a result, the instance 1004 is identical to the original cell_U, with a width of 10 units and a height of 5 units. Reference numeral 1006 designates an instance of a parent cell designated cell_W that contains an instance 1008 citing cell_U with magnify set to 1.5. As a result, the patterns inside instance 1008 are 50% larger than the original patterns comprising cell_U. The width of the instance 1008 is 15 units (1.5 times the width of the original cell_U) and the height thereof is 7.5 units (1.5 times the height of the original cell_U). As the magnify value will affect the coordinates of the patterns within the parent, this factor must be considered during translation, described below.

As previously noted, it will be recognized that any type of layout pattern modification, such as OPC, LOP, dummy insertion, or other transformations, may affect geometric patterns in the layout. In addition to geometry, such transformations may destroy layout hierarchy by partial or complete flattening. In contrast to the original layout, the revised layout is hard to analyze, review, modify and/or perform LVS/LPE/post-simulation at the sub-cell level since the hierarchy is destructively altered by the transformation. On the other hand, such processes are ineffective, inefficient, and time-consuming when performed at the top level. One manner in which the difficulties caused by pattern modification may be alleviated would be to make the hierarchy of revised layout more similar that of the original layout.

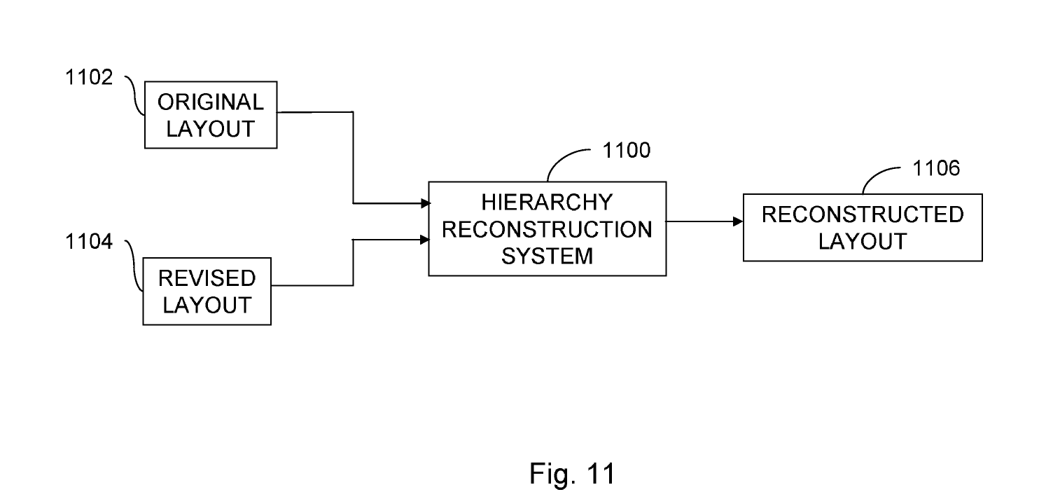

As illustrated in FIG. 11, one embodiment comprises a hierarchy reconstruction system 1100, which, as will be described in detail below, receives as inputs an original layout 1102, including hierarchy information, and a revised layout 1104 modified from the original layout 1102 as a result of pattern modification, and outputs a reconstructed layout 1106 that has a hierarchy similar to that of the original layout 1102 and the same geometric patterning as the revised layout 1104.

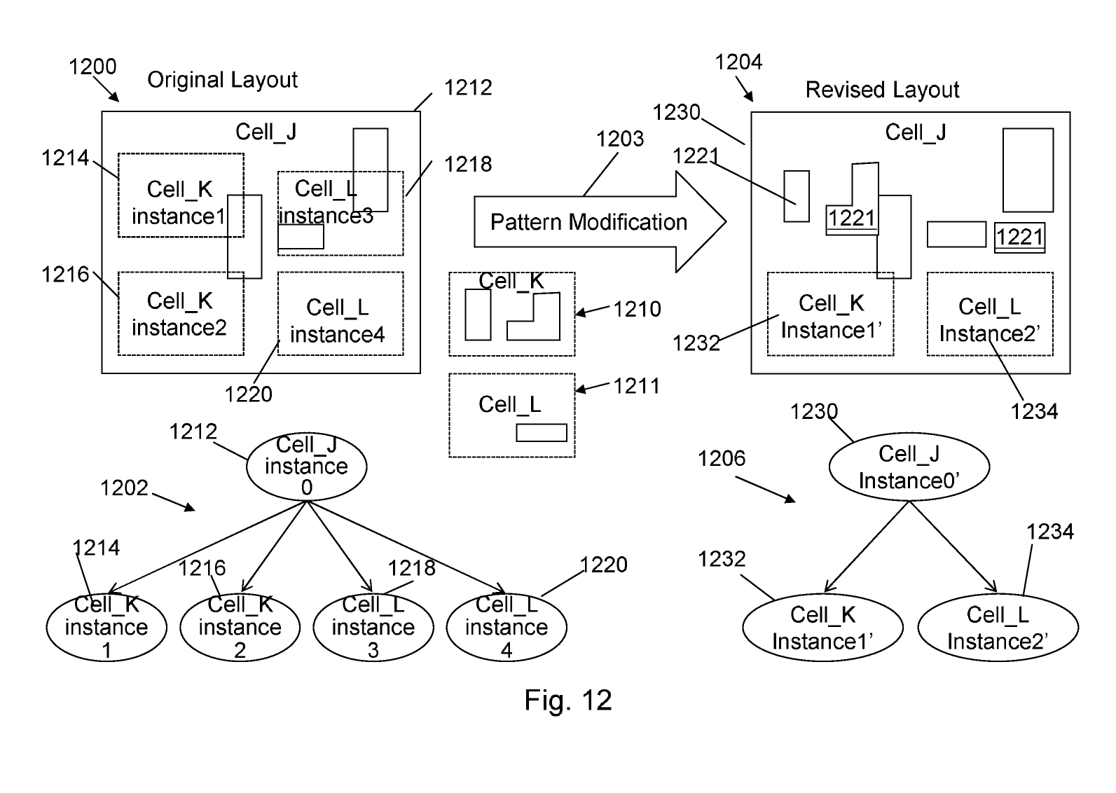

FIG. 12 illustrates the effects of pattern modification on a cell designated cell_J. As shown in FIG. 12, an original layout 1200 of cell_J has a corresponding hierarchy 1202. After pattern modification 1203, a revised layout 1204 of cell_J has a corresponding hierarchy 1206. As noted above, any of OPC, LOP, dummy insertion, or other transformations may be the source of pattern modification 1203. Each of the layouts and hierarchies shown in FIG. 12 comprise three cells (cell_J, cell_K, and cell_L). The layouts of cell_K and cell_L are respectively designated by reference numerals 1210 and 1211. The original layout 1200 and hierarchy 1202 comprise five instances 1212-1220. The instance 1212 cites to the parent cell, cell_J, the instances 1214 and 1216 cite to cell_K, and the instances 1218 and 1220 cite to cell_L.

In contrast, as seen in the revised layout 1204, it will be noted that certain patterns 1221 of cell_K and cell_L were introduced into parent cell cell_J. As a result, the patterns included in cell_J and the revised layout 1204 and hierarchy 1206 are completely different than the original layout 1200 and hierarchy 1202. In other words, the hierarchy of cell_J was disordered by the pattern modification 1203. In particular, the layout 1204 and hierarchy 1206 comprise three modified instances 1230-1234. The instance 1230 cites to cell_J, the instance 1232 cites to cell_K, and the instance 1234 cites to cell_L.

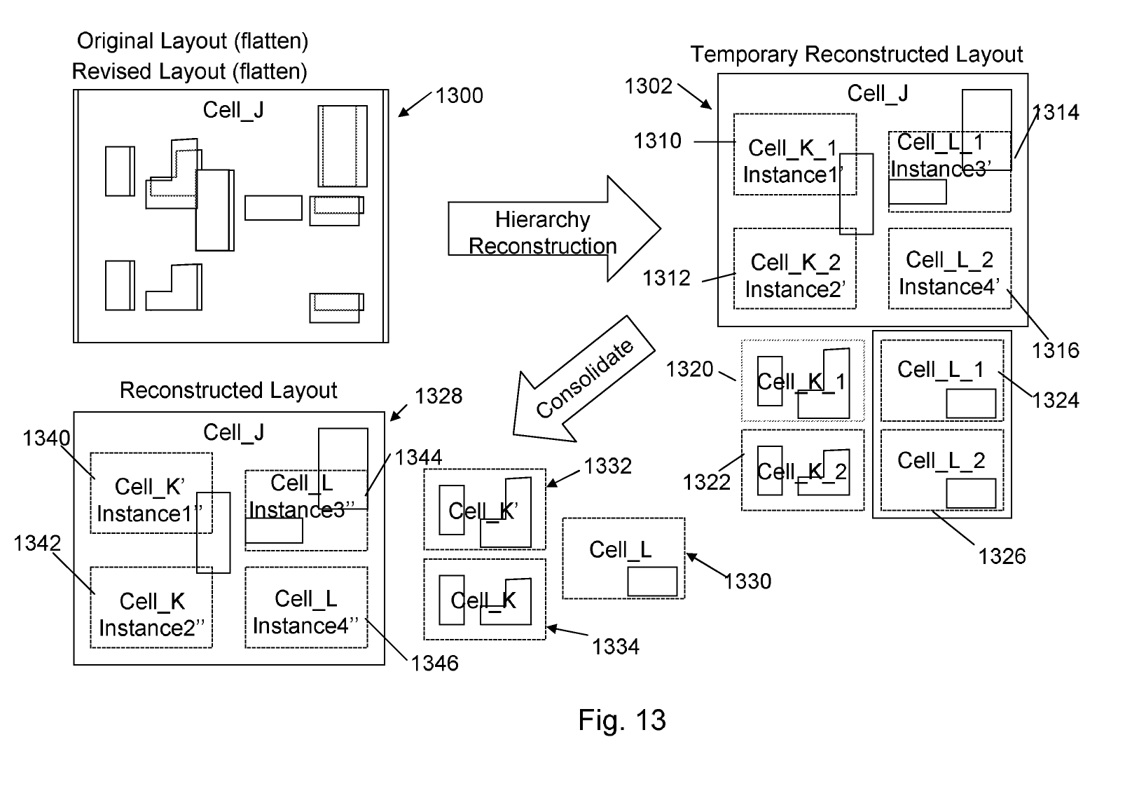

As shown in FIG. 13, a layout 1300 comprises the revised layout 1204 of cell_J overlaid on the original layout 1200 of cell_J. The effects of pattern modification 1203 on the layout of cell_J are clearly evident from the layout 1300. To achieve a hierarchy similar to the original layout 1200 in the revised layout 1204, the patterns in the two layouts must be compared to determine to which cell the revised pattern belongs in the original layout. Once the flattened patterns in the original and revised layouts are compared with one another, the revised layout pattern is said to belong to the instance the original layout pattern belongs to. By tracing all of the patterns in this manner and as described in detail below, a hierarchy can be “reconstructed” that it is close the original.

After determining the cell to which each pattern belongs, new cells will be created in a temporary reconstructed layout 1302, as shown in FIG. 13. Hierarchy reconstruction techniques described herein are applied to the layouts 1200 and 1204 to create a temporary reconstructed layout 1302. The temporary reconstructed layout 1302 comprises instances 1310-1316. The instance 1310 cites to a temporary cell designated cell_K_1 having a layout 1320. The instance 1312 cites to a temporary cell designated cell_K_2 having a layout 1322. The instance 1314 cites to a temporary cell designated cell_L_1 having a layout 1324. The instance 1316 cites to a temporary cell designated cell_L_2 having a layout 1326.

To consolidate the temporary reconstructed layout 1302 into a reconstructed layout 1328, a comparison of the cells cited in the layout 1302 is performed. It is noted that the patterns 1324 and 1326, citing to cells cell_L_1 and cell_L_2, respectively, are identical; therefore, they are consolidated into a single layout 1330. The layout 1330 is similar, if not exactly identical to, the layout 1211 (FIG. 12); therefore, the layout 1330 is designated cell_L. Conversely, the layouts 1320 and 1322, citing to cells cell_K_1 and cell_K_2, are different; therefore, they will continue to cite to different cells, renamed cell_K′ having a layout 1332 and cell_K having a layout 1334 (which is identical to the layout 1210 in FIG. 12). As a result, the reconstructed layout 1328 comprises an instance 1340 that cites to cell_K′, an instance 1342 that cites to cell_K, and two instances 1344, 1346, each of which cite to cell_L.

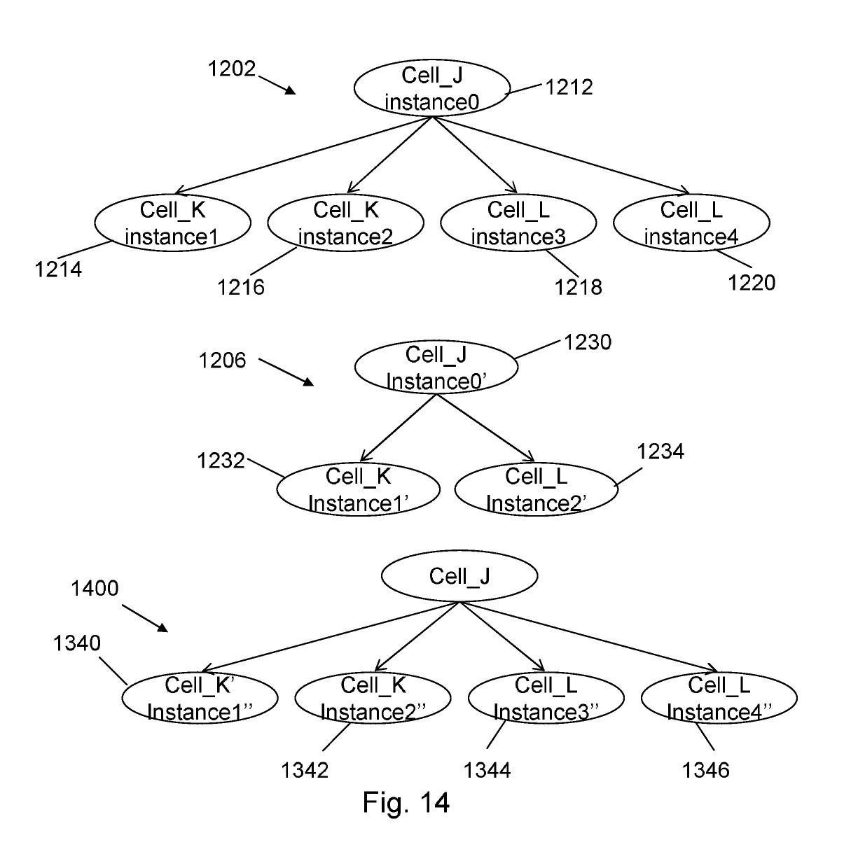

FIG. 14 illustrates the hierarchy tree 1202 corresponding to the original layout 1200, the hierarchy tree 1206 corresponding to the revised layout 1202, and a hierarchy tree 1400 corresponding to the reconstructed layout 1328. As seen from FIG. 14, the hierarchy tree 1400 is much more similar to the hierarchy tree 1202 than the hierarchy tree 1206 is, making it much more useful for analysis, simulation, and other purposes.

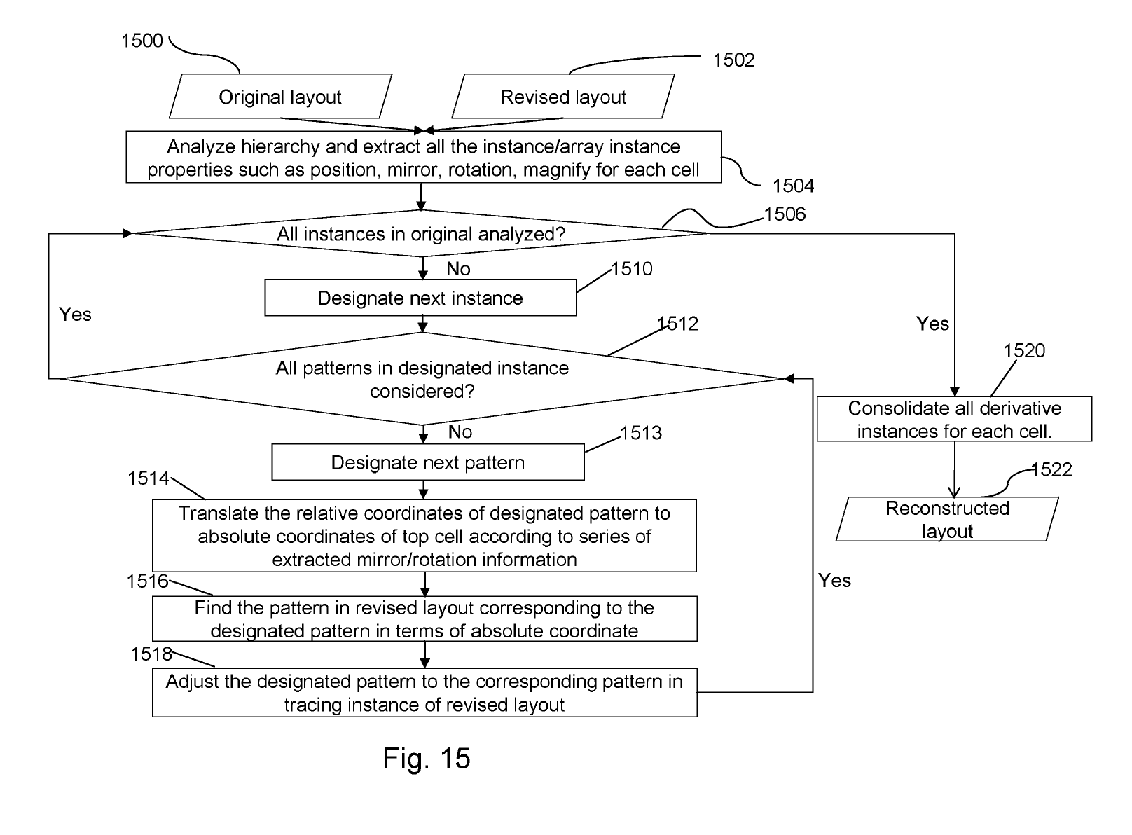

FIG. 15 illustrates operation of a hierarchy reconstruction system, such as the system 1100 (FIG. 11) in accordance with one embodiment. As shown in FIG. 15, an original layout 1500 and a revised layout 1502 resulting from pattern modification of the original layout 1500, both in hierarchical form, are provided as inputs to a hierarchy reconstruction system. In step 1504, the hierarchies of the layouts 1500, 1502, are analyzed and all of the instance and array instance properties, such as position, mirror, rotation, and magnification, are extracted for each cell. In step 1506, a determination is made whether all of the instances comprising the original layout have been analyzed. If not, in step 1511, a next one of the instances is designated for analysis. In step 1512, a determination is made whether all of the patterns in the designated instance have been considered. If not, in step 1513, the next pattern in the designated instance is designated for consideration. In step 1514, the relative coordinates of the designated pattern in the original layout are translated to a set of absolute coordinates, which in one embodiment is defined as the coordinates of the top cell of the hierarchy, according to the properties extracted in step 1504. In one embodiment, coordinate translation is performed as described in connection with FIGS. 8A-8D.

Next, in step 1516, the pattern in the revised layout corresponding to the designated pattern is located in terms of absolute coordinates. In step 1518, the designated pattern is deemed to belong to a temporary instance corresponding to the designated instance, as illustrated in FIG. 13, especially reconstructed layout 1302 and instances 1310-1316 therein. Upon completion of step 1518, execution then returns to step 1512.

If in step 1512 it is determined that all of the patterns of the designated instance have been considered, execution returns to step 1506. If in step 1506 it is determined that all of the instances in the original layout have been analyzed, execution proceeds to step 1520, in which all derivative instances for each cell are consolidated, thereby to create the reconstructed layout, as described above with reference to FIG. 13. Upon completion of step 1520, the reconstructed layout and corresponding hierarchy 1522 are output from the hierarchy reconstruction system.

It is understood that various different combinations of the above-listed embodiments and steps can be used in various sequences or in parallel, and there is no particular step that is critical or required. Moreover, each of the modules depicted in the drawings and the hierarchy reconstruction system illustrated in FIG. 11 can be implemented on multiple devices, including computing devices, and implementation of multiple ones of the depicted modules may be combined into a single device, including a computing device. Moreover, the hierarchy reconstruction system may comprising instructions for execution by a computer processor and stored on a non-transitory computer-readable medium, such as a memory device, hard disk, and/or CD. Furthermore, features illustrated and discussed above with respect to some embodiments can be combined with features illustrated and discussed above with respect to other embodiments. Accordingly, all such modifications are intended to be included within the scope of this invention.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method for producing a reconstructed layout for an integrated circuit design from an original layout and a revised layout, the method comprising:
for each pattern of the original layout:
determining a pattern of the revised layout that corresponds to the pattern of the original layout; and
assigning the corresponding pattern of the revised layout to a temporary instance, the temporary instance corresponding to an instance of the pattern of the original layout and citing to a temporary cell;
creating a temporary reconstructed layout from the temporary instances; and
producing the reconstructed layout from the temporary reconstructed layout, wherein a hierarchy of the reconstructed layout is similar to a hierarchy of the original layout.

2. The method of claim 1 wherein a patterning of the reconstructed layout is identical to a patterning of the revised layout.

3. The method of claim 1 wherein the producing comprises consolidating the temporary instances such that all identical ones of the temporary instances cite to a single cell to produce the reconstructed hierarchy.

4. The method of claim 3 wherein the consolidating comprises creating a new cell to which the temporary instances cite.

5. The method of claim 1 further comprising, prior to the determining, analyzing the layouts to determine properties of instances comprising the layouts.

6. The method of claim 1 wherein the properties comprise at least one of position, minor, rotation, and magnification.

7. The method of claim 1 wherein the determining comprises translating relative coordinates of the pattern of the original layout to a set of absolute coordinates.

8. The method of claim 7 wherein the set of absolute coordinates comprises a coordinate set of a top cell of the layouts.

9. The method of claim 1 wherein pattern modification performed on the original layout results in the revised layout.

10. A method for producing a reconstructed layout for an integrated circuit design from an original layout and a revised layout resulting from pattern modification performed on the original layout, the method comprising:
extracting properties for all instances of the original layout;
for each pattern of the original layout:
determining a pattern of the revised layout that corresponds to the pattern of the original layout;
assigning the corresponding pattern of the revised layout to a temporary instance, the temporary instance corresponding to the one of the instances to which the pattern of the original layout belongs and citing to a temporary cell;
creating a temporary reconstructed layout from the temporary instances; and
consolidating the temporary instances such that all identical ones of the temporary instances cite to a single cell to produce the reconstructed layout, wherein a hierarchy of the reconstructed layout is similar to a hierarchy of the original layout and a patterning of the reconstructed layout is identical to a patterning of the revised layout.

11. The method of claim 10 wherein the consolidating comprises creating a new cell to which the temporary instances cite.

12. The method of claim 10 wherein the properties comprise at least one of position, minor, rotation, and magnification.

13. The method of claim 10 wherein the determining comprises translating relative coordinates of the pattern of the original layout to a set of absolute coordinates of a top cell of the layouts.

14. The method of claim 10 wherein the pattern modification results from at least one of optical proximity correction (“OPC”), logical operations (“LOP”), dummy insertion, and other transformations.

15. A system for producing a reconstructed layout for an integrated circuit design from an original layout and a revised layout, the system comprising:
for each pattern of the original layout:
means for determining a pattern of the revised layout that corresponds to the pattern of the original layout; and
means for assigning the corresponding pattern of the revised layout to a temporary instance, the temporary instance corresponding to an instance of the pattern of the original layout and citing to a temporary cell;
means for creating a temporary reconstructed layout from the temporary instances; and
means for producing the reconstructed layout from the temporary reconstructed layout, wherein a hierarchy of the reconstructed layout is similar to a hierarchy of the original layout.

16. The system of claim 15 wherein a patterning of the reconstructed layout is identical to a patterning of the revised layout.

17. The system of claim 15 wherein the means for producing comprises means for
consolidating the temporary instances such that all identical ones of the temporary instances cite to a single cell to produce the reconstructed hierarchy.

18. The system of claim 17 wherein the means for consolidating comprises means for creating a new cell to which the temporary instances cite.

19. The system of claim 15 further comprising, prior to the determining, analyzing the layouts to determine properties of instances comprising the layouts, wherein the properties comprise at least one of position, minor, rotation, and magnification.

20. The system of claim 15 wherein the means for determining comprises means for translating relative coordinates of the pattern of the original layout to a set of absolute coordinates.
